(19) United States
(12) Patent Application Publication
(10) Pub. No.: US 2001/0024342 A1
(43) Pub. Date: Sep. 27, 2001

(54) Magnetic head capable of correctly reproducing signal by domain enlargement and recording/reproducing apparatus employing the same

(75) Inventors: Kenichiro Mitani, Anpachi-gun (JP); Naoyuki Takagi, Fuwa-gun (JP); Hitoshi Noguchi, Gifu-shi (JP); Atsushi Yamaguchi, Motosu-gun (JP); Hiroki Ishida, Anpachi-gun (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Sanyo Electric Co., Ltd, Moriguchi-shi (JP)

(21) Appl. No.: 09/803,925

(22) Filed: Mar. 13, 2001

(30) Foreign Application Priority Data
Mar. 15, 2000 (JP) 2000-072668(P)

(51) Int. Cl. G11B 11/10; G11B 5/133

(52) U.S. Cl. 360/127; 369/13

(57) ABSTRACT

A magnetic head comprises a core having a first leg, a second leg and a third leg and a coil wound on the second leg of the core. An end of the second leg is formed by a first portion formed by two inclined surfaces and a second portion formed by a flat surface. When a current is fed to the coil, a magnetic field oblique to a magnetooptical recording medium is generated from the first portion of the second leg, and a magnetic field perpendicular to the magnetooptical recording medium is generated from the second portion. Consequently, a magnetic field perpendicular to the magnetooptical recording medium can be applied to the magnetooptical recording medium for recording a signal, while a magnetooptical field having a prescribed angle with respect to the in-plane direction of the magnetooptical recording medium can be applied to the magnetooptical recording medium for reproducing a signal.

### BACKGROUND OF THE INVENTION

1. Field of the Invention

The present invention relates to a magnetic head employed for recording a signal in a magneto-optical recording medium and reproducing the signal by domain enlargement and a recording/reproducing apparatus employing the same.

2. Description of the Prior Art

A magneto-optical recording medium is watched with interest as a rewritable recording medium having a large storage capacity and high reliability, and now being put into practice as a computer memory or the like. Further, a magneto-optical recording medium having a recording capacity of 6.0 Gbytes has recently been standardized as the AS-MO (advanced storaged magneto-optical disk) standard, to be put into practice.

There has also been proposed a magneto-optical recording medium having a recording capacity of 14 Gbytes according to a domain enlargement reproducing system reproducing a signal by enlarging magnetic domains of a recording layer and transferring the enlarged magnetic domains to a reproducing layer. According to the domain enlargement reproducing system, the signal is recorded in the magneto-optical recording medium by applying a magnetic field modulated by a recorded signal perpendicularly to the magneto-optical recording medium and forming magnetic domains magnetized in different directions on the recording layer.

Further, the signal reproduction from the magneto-optical recording medium by the domain expansion reproduction system is done by applying an alternating magnetic field having a constant period perpendicular to the magneto-optical medium to transfer and enlarge the domains of the recording layer to the reproduction layer, and by detecting the transferred and enlarged domains with the laser beam.

However, in the conventional magnetic domain expansion reproduction system, which applies an alternating magnetic field from the direction perpendicular to the magneto-optical medium, there was a problem that the center of the domain cannot be correctly transferred to the reproduction layer, when the domain length formed on the recording layer was longer, because the leakage magnetization at the center of the domain becomes weaker than the one at the edge of the domain.

Consequently, the signal cannot be correctly reproduced in the domain expansion reproducing system.

In order to solve this problem, there has been proposed means of applying an alternating field having a prescribed angle with respect to the in-plane direction of the magneto-optical recording medium thereby increasing a component of a leakage field in the in-plane direction on an end of the magnetic domain and facilitating transfer from the end of the magnetic domain to the reproducing layer (H. Awano, A. Yamaguchi, S. Sumi, S. Ohnuki, H. Shirai, N. Ohta and K. Torazawa: Appl. Phys. Lett., 69 (27) 4257 (1996)).

In order to reproduce a signal by domain enlargement by applying an alternating field having a prescribed angle with respect to the in-plane direction of a magneto-optical recording medium, a dedicated magnetic head must be employed for generating the alternating field having a prescribed angle with respect to the in-plane direction of the magneto-optical recording medium. In order to record a signal in the magneto-optical recording medium, on the other hand, a magnetic field must be applied perpendicularly to the magneto-optical recording medium. However, a conventional magnetic head cannot apply a magnetic field modulated by a recorded signal perpendicularly to the magneto-optical recording medium for recording the signal and apply an alternating field having a prescribed angle with respect to the in-plane direction of the magneto-optical recording medium for reproducing the signal.

### SUMMARY OF THE INVENTION

Accordingly, an object of the present invention is to provide a magnetic head capable of applying a magnetic field modulated by a recorded signal perpendicularly to a magneto-optical recording medium for recording the signal and applying an alternating field having a prescribed angle with respect to the in-plane direction of the magneto-optical recording medium for reproducing the signal and a recording/reproducing apparatus employing the same.

The magnetic head according to the present invention is a magnetic head applying magnetic fields to a magneto-optical recording medium, which includes a first field generation part generating a first magnetic field substantially perpendicular to the magneto-optical recording medium and a second field generation part generating a second magnetic field having a prescribed angle with respect to the in-plane direction of the magneto-optical recording medium.

Preferably, the second field generation part generates two second magnetic fields symmetrical with respect to the normal direction of the magneto-optical recording medium.

Preferably, a component of the second magnetic field in the in-plane direction of the magneto-optical recording medium has higher field strength than a component of the second magnetic field perpendicular to the magneto-optical recording medium.

According to another aspect of the present invention, the magnetic head is a magnetic head applying magnetic fields to a magneto-optical recording medium, which comprises a core including a first leg, a second leg and a third leg, substantially in the form of square poles, extending toward the magneto-optical recording medium and a coil wound on the second leg of the core, while the second leg is arranged between the first leg and the third leg and includes a first portion and a second portion, the first portion has first and second inclined surfaces so that the center of a sectional structure in the tangential direction of the magneto-optical recording medium is pointed toward the magneto-optical recording medium, the second portion has a flat surface opposed to the magneto-optical recording medium, the first leg has a third inclined surface receiving a magnetic line outgoing from the first inclined surface, and the third leg has a fourth inclined surface receiving a magnetic line outgoing from the second inclined surface.

According to still another aspect of the present invention, the magnetic head is a magnetic head applying magnetic fields to a magneto-optical recording medium, which comprises a core including a first leg, a second leg and a third leg, substantially in the form of square poles, extending toward the magneto-optical recording medium, a first coil wound on the second leg of the core and a second coil wound on the third leg of the core, while the second leg is arranged between the first leg and the third leg and has a flat surface opposed to the magneto-optical recording medium and a first inclined surface inclined to be separated from the magneto-optical recording medium in the tangential direction of the magneto-optical recording medium, and the third leg has a second inclined surface receiving a magnetic line outgoing from the first inclined surface.

According to a further aspect of the present invention, the recording/reproducing apparatus is a recording/reproducing apparatus recording and reproducing a signal in and from a magneto-optical recording medium, which comprises a magnetic head including a first field generation part generating a first magnetic field substantially perpendicular to the magneto-optical recording medium and a second field generation part generating a second magnetic field having a prescribed angle with respect to the in-plane direction of the magneto-optical recording medium, an optical pickup irradiating the magneto-optical recording medium with a laser beam and detecting the reflected laser beam and a magnetic head moving mechanism moving the magnetic head for applying a magnetic field generated from the first field generation part of the magnetic head to an area of the magneto-optical recording medium irradiated with the laser beam for recording a signal in the magneto-optical recording medium while applying a magnetic field generated from the second field generation part of the magnetic head to an area of the magneto-optical recording medium irradiated with the laser beam for reproducing a signal from the magneto-optical recording medium.

According to a further aspect of the present invention, the recording/reproducing apparatus is a recording/reproducing apparatus recording and reproducing a signal in and from a magneto-optical recording medium, which comprises a magnetic head applying magnetic fields to the magneto-optical recording medium, a magnetic head driving circuit driving the magnetic head, an optical pickup irradiating the magneto-optical recording medium with a laser beam and detecting the reflected laser beam and a magnetic head holding/moving mechanism holding or moving the magnetic head, while the magnetic head includes a core including a first leg, a second leg and a third leg, substantially in the form of square poles, extending toward the magneto-optical recoding medium and a coil wound on the second leg of the core, the second leg is arranged between the first leg and the third leg and has a first portion and a second portion, the first portion has first and second inclined surfaces so that the center of a sectional structure in the tangential direction of the magneto-optical recording medium is pointed toward the magneto-optical recording medium, the second portion has a flat surface opposed to the magneto-optical recording medium, the first leg has a third inclined surface receiving a magnetic line outgoing from the first inclined surface, the third leg has a fourth inclined surface receiving a magnetic line outgoing from the second inclined surface, and the magnetic head holding/moving mechanism holds the magnetic head so that the first, second and third legs of the magnetic head are arranged in the tangential direction of the magneto-optical recording medium, moves and holds the magnetic head so that a magnetic field generated from the second portion of the second leg of the magnetic head is applied to an area of the magneto-optical recording medium irradiated with the laser beam for recording a signal in the magneto-optical recording medium, and moves and holds the magnetic head so that a magnetic field generated from the first portion of the second leg of the magnetic head is applied to an area of the magneto-optical recording medium irradiated with the laser beam at a prescribed angle with respect to the in-plane direction of the magneto-optical recoding medium for reproducing a signal from the magneto-optical recording medium.

According to a further aspect of the present invention, the recording/reproducing apparatus is a recording/reproducing apparatus recording and reproducing a signal in and from a magneto-optical recording medium, which comprises a magnetic head applying magnetic fields to the magneto-optical recording medium, a magnetic head driving circuit driving the magnetic head, an optical pickup irradiating the magneto-optical recording medium with a laser beam and detecting the reflected laser beam and a magnetic head holding/moving mechanism holding or moving the magnetic head, while the magnetic head includes a core including a first leg, a second leg and a third leg, substantially in the form of square poles, extending toward the magneto-optical recording medium, a first coil wound on the second leg of the core and a second coil wound on the third leg of the core, the second leg is arranged between the first leg and the third leg and has a flat surface opposed to the magneto-optical recording medium and a first inclined surface inclined to be separated from the magneto-optical recording medium in the tangential direction of the magneto-optical recording medium, the third leg has a second inclined surface receiving a magnetic line outgoing from the first inclined surface, and the magnetic head holding/moving mechanism holds the magnetic head so that the first, second and third legs of the magnetic head are arranged in the tangential direction of the magneto-optical recording medium, moves and holds the magnetic head so that a magnetic field generated from the flat surface of the second leg is applied to an area of the magneto-optical recording medium irradiated with the laser beam for recording a signal in the magneto-optical recording medium, and moves and holds the magnetic head so that a magnetic field generated from the first inclined surface of the second leg or the second inclined surface of the third leg is applied to an area of the magneto-optical recording medium irradiated with the laser beam at a prescribed angle with respect to the in-plane direction of the magneto-optical recording medium for reproducing a signal from the magneto-optical recording medium.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a magnetic head according to the present invention;

FIG. 2 illustrates a sectional structure of the magnetic head shown in FIG. 1;

FIG. 3 illustrates another sectional structure of the magnetic head shown in FIG. 1;

FIG. 4 is a diagram for illustrating a holding/moving mechanism for the magnetic head and an optical pickup;

FIG. 5 is a diagram for illustrating the principle of moving a support plate shown in FIG. 4 with magnetic force;

FIG. 6 is a diagram for illustrating a moving mechanism for the magnetic head;

FIGS. 7 and 8 are diagrams for illustrating reproduction of a signal by domain enlargement with the magnetic head shown in FIG. 1;

FIG. 9 is a diagram for illustrating transfer of a magnetic domain with application of an oblique magnetic field to a magneto-optical recording medium;

FIGS. 10A, 10B, 11A and 11B are diagrams for illustrating the principle of domain enlargement reproduction with application of an oblique magnetic field to the magneto-optical recording medium;

FIG. 12A is a sectional view of a recording layer of the magneto-optical recording medium, and FIG. 12B is a timing chart of signals for reproducing a signal from the magneto-optical recording medium;

FIG. 13 is a block diagram of a recording/reproducing apparatus according to the present invention;

FIG. 14 is a circuit diagram of a composition circuit shown in FIG. 13;

FIG. 15A is a plan view showing a track of the magneto-optical recording medium, FIG. 15B is a plan view of a photodetector included in the optical pickup shown in FIG. 13, and FIG. 15C is a circuit diagram of a circuit detecting magneto-optical signals and a fine clock marks;

FIG. 16A is a plan view showing the track of the magneto-optical recording medium, and FIG. 16B is a timing chart of signals for illustrating generation of a clock;

FIG. 17 is a block diagram of a driving signal generation circuit shown in FIG. 13;

FIG. 18 is a timing chart of signals for illustrating operation of the driving signal generation circuit shown in FIG. 17;

FIG. 19 is a perspective view showing another magnetic head according to the present invention; and

FIG. 20 is a sectional view of the magnetic head shown in FIG. 19.

### DESCRIPTION OF THE PREFERRED EMBODIMENTS

An embodiment of the present invention is now described in detail with reference to the drawings. Referring to the drawings, parts identical or corresponding to each other are denoted by the same reference numerals, and redundant description is not repeated.

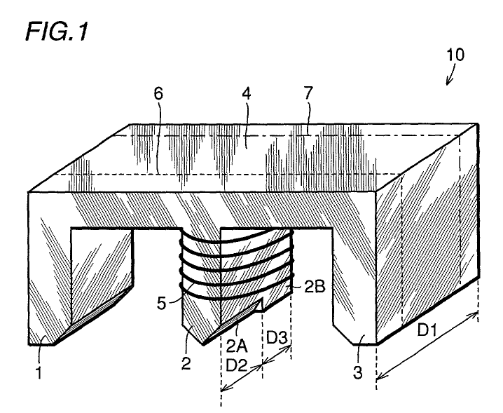

Referring to FIG. 1, a magnetic head 10 according to the embodiment of the present invention comprises a core 4 and a coil 5. The core 5 includes a first leg 1, a second leg 2 and a third leg 3. The coil 5 is wound on the second leg 2. The core 4 consists of ferrite, for example. A first end of the second leg 2 is formed by a first portion 2A and a second portion 2B. The first portion 2A consists of two inclined surfaces, and the second portion 2B consists of a flat surface.

The core 4 has a depth D1 of 500 μm, the first portion 2A of the second leg 2 has a depth D2 of 250 μm, and the second portion 2B of the second leg 2 has a depth D3 of 250 μm.

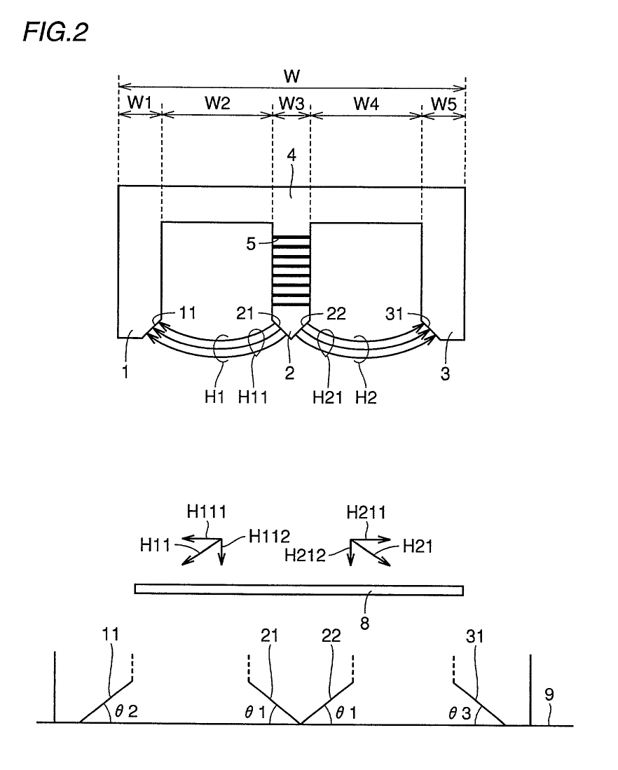

A sectional structure of the core 4 taken along the line 6 in FIG. 1 is described with reference to FIG. 2. The second leg 2 of the core 4 is arranged between the first leg 1 and the third leg 3. A first end of the first leg 1 includes an inclined surface 11. The first end of the second leg 2 includes the inclined surfaces 21 and 22. A first end of the third leg 3 includes an inclined surface 31. The inclined surfaces 21 and 22 of the second leg 2 are so formed that the first end of the second leg 2 has a pointed sectional structure. The inclined surface 11 of the first leg 1 is opposed to the inclined surface 21 of the second leg 2, and the inclined surface 31 of the third leg 3 is opposed to the inclined surface 22 of the second leg 2. When a current is fed to the coil 5 wound on the second leg 2, therefore, a magnetic field H1 is generated between the inclined surface 21 of the second leg 2 and the inclined surface 11 of the first leg 1, and a magnetic field H2 is generated between the inclined surface 22 of the second leg 2 and the inclined surface 31 of the third leg 3. In this case, the magnetic field H1 outgoes from the inclined surface 21 of the second leg 2, and is incident on the inclined surface 1 of the first leg 1. The magnetic field H2 outgoes from the inclined surface 22 of the second leg 2, and is incident on the inclined surface 31 of the third leg 3.

The width W1 of the first leg 1 of the core 4, the width W3 of the second leg 2 and the width W5 of the third leg 3 are 200 μm. The interval W2 between the first leg 1 and the second leg 2 and the interval W4 between the second leg 2 and the third leg 3 are 500 μm. Therefore, the total width W of the core 4 is 600 μm.

According to the present invention, a signal is reproduced from a magneto-optical recording medium 8 by domain expansion with a magnetic field H11, closer to the inclined surface 21, included in the magnetic field H1 outgoing from the inclined surface 21 of the second leg 2 and a magnetic field H21, closer to the inclined surface 22, included in the magnetic field H2 outgoing from the inclined surface 22. The magnetic field H11 consists of a field component H111 in the in-plane direction of the magneto-optical recording medium 8 and a field component H112 perpendicular to the magneto-optical recording medium 8. The magnetic field H21 consists of a field component H211 in the in-plane direction of the magneto-optical recording medium 8 and a field component H212 perpendicular to the magneto-optical recording medium 8. Therefore, the magnetic fields H11 and H21 are applied at a prescribed angle with respect to the in-plane direction of the magneto-optical recording medium 8. The magnetic fields H11 and H21 are also referred to as “magnetic fields including field components in the in-plane direction of the magneto-optical recording medium”.

While the first portion 2A of the second leg 2 of the core 4 is formed by the two inclined surfaces 21 and 22 in order to generate the magnetic fields H11 and H21, the inclination θ1 of the inclined surfaces 21 and 22 with respect to the plane 9 of the magneto-optical recording medium 8 is 30°. The inclination θ2 of the inclined surface 11 of the first leg 1 and the inclination θ3 of the inclined surface 31 of the third leg 3 with respect to the plane 9 of the magneto-optical recording medium 8 are 30°, identically to the inclination θ1. In the magnetic fields H11 and H21, therefore, the in-plane component H111 or H211 is larger than the perpendicular component H112 or H212.

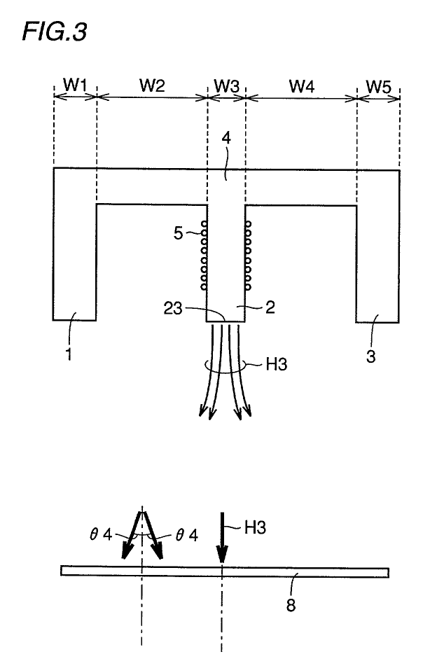

Another sectional structure of the core 4 taken along the line 7 in FIG. 1 is described with reference to FIG. 3. In the section taken along the line 7, the first end of the second leg 2, formed by the second portion 2B, is provided with a flat surface 23. The first ends of the first leg 1 and the third leg 3 are also provided with flat surfaces. When a current is fed to the coil 5 wound on the second leg 2, therefore, a magnetic field H3 outgoes from the flat surface 23 of the second leg 2. This magnetic field H3 is perpendicular to the magneto-optical recording medium 8. According to the present invention, the magnetic field H3 is applied to the magneto-optical recording medium 8, for recording a signal in the magneto-optical recording medium 8. The magnetic field H3 outgoing from the flat surface 23 of the second leg 2 is not restricted to the one forming an angle of 0° with the normal direction of the magneto-optical recording medium 8, but may form an angle θ4 with the normal direction of the magneto-optical recording medium 8, and the angle θ4 is set to about 10°.

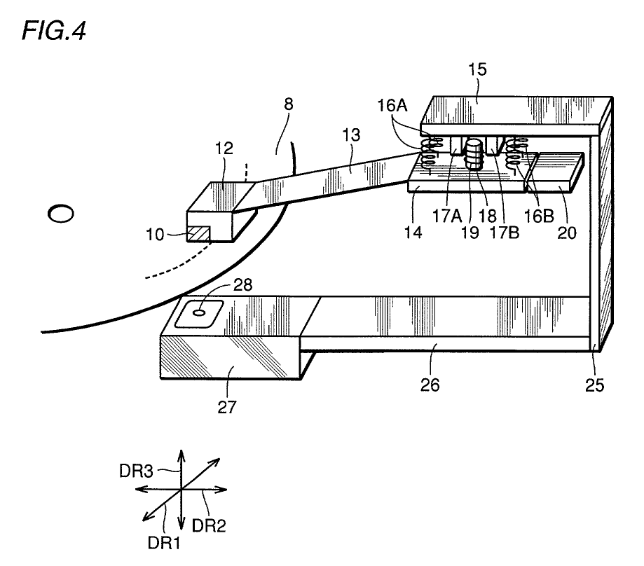

Arrangement of an optical pickup 27 and the magnetic head 10 recording or reproducing a signal in or from the magneto-optical recording medium 8 is described with reference to FIG. 4. The optical pickup 27 is arranged on one side of the magneto-optical recording medium 8, and the magnetic head 10 is arranged on the other side of the magneto-optical recording medium 8. The magnetic head 10 is provided on a slider 12. The optical pickup 27 condenses and applies a laser beam to the magneto-optical recording medium 8 through an objective lens 28, and the magnetic head 10 applies the magnetic fields H11, H21 and H3 to the magneto-optical recording medium 8 from the side opposite to that irradiated with the laser beam. When the magneto-optical recording medium 8 is rotated, the air is introduced into the clearance between the magneto-optical recording medium 8 and the slider 12 so that the magnetic head 10 floats up from the magneto-optical recording medium 8. Therefore, an arm 13 in the form of a plate spring presses the slider 12 in the normal direction DR3 of the magneto-optical recording medium 8 by a mechanism described later. Consequently, the magnetic head 10 stops floating on a position where the floating force resulting from rotation of the magneto-optical recording medium 8 and the force of the arm 13 pressing the slider 12 in the normal direction DR3 balance with each other. In general, the interval between the floating magnetic head 10 and the magneto-optical recording medium 8 is about 5 to 20 μm.

The arm 13 is fixed to a support plate 14. The support plate 14 is connected with a top plate 15 by four springs 16A and 16B. The top plate 15 is connected with a support plate 26 for the optical pickup 27 through a support plate 25. When the optical pickup 27 seeks in the radial direction DR2 of the magneto-optical recording medium 8, therefore, the magnetic head 10 is moved in the radial direction DR2 of the magneto-optical recording medium 8 through the support plates 26 and 25, the top plate 15, the support plate 14 and the arm 13. Once the optical axis of the laser beam is aligned with the center of a magnetic field, therefore, the center of the magnetic field is not displaced from the optical axis of the laser beam due to the seek of the optical pickup 27.

Two magnets 17A and 17B are mounted on the top plate 15, and a core 18 having a coil 19 wounded thereon is formed on the support plate 14 between the magnets 17A and 17B. When a current is fed to the coil 19, therefore, the coil 19 receives the magnetic force from the magnets 17A and 17B to move the support plate 14 in the normal direction DR3 of the magneto-optical recording medium 8. Thus, the arm 13 in the form of a plate spring presses the slider 12 against the magneto-optical recording medium 8.

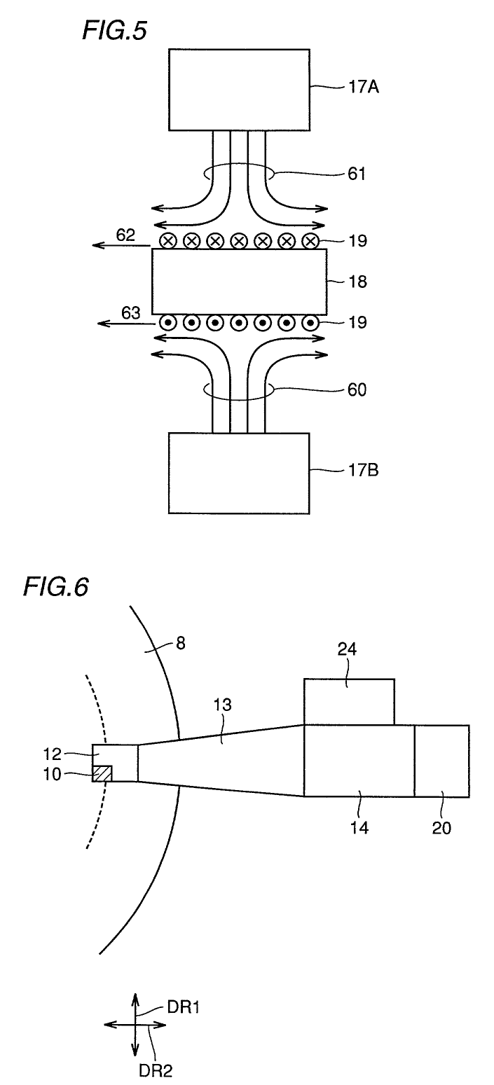

The principle of the coil 19, wound on the core 18, receiving magnetic force from the magnets 17A and 17B when fed with a current is described with reference to FIG. 5. The current fed to the coil 19 flows in opposite directions on the sides of the magnets 17A and 17B. When the magnets 17A and 17B are formed by the same N poles, the magnet 17A emits a magnetic line 61 toward the coil 19, and the magnet 17B emits a magnetic line 60 toward the coil 19. Consequently, the coil 19 receives magnetic force 62 on the side of the magnet 17A, and receives magnetic force 63 on the side of the magnet 17B. The magnetic force 62 is in the same direction as the magnetic force 63, and hence the core 18 is moved in a constant direction.

Referring again to FIG. 4, the core 18 and the coil 19 provided on the support plate 14 are moved in the normal direction DR3 of the magneto-optical recording medium 8 due to the principle described with reference to FIG. 5. The core 18 and the coil 19 can be moved in a direction approaching the magneto-optical recording medium 8 or in a direction separating from the magneto-optical recording medium 8 by changing the direction of the current fed to the coil 19. Thus, the slider 12 can be properly pressed against the magneto-optical recording medium 8 through the arm 13 in the form of a plate spring.

Piezoelectric elements (not shown in FIG. 4) are set on the support plate 14 for moving the magnetic head 10 in the tangential direction DR1 and the radial direction DR2 of the magneto-optical recording medium 8.

The mechanism for moving the magnetic head 10 in the tangential direction DR1 and the radial direction DR2 of the magneto-optical recording medium 8 is described with reference to FIG. 6. A piezoelectric element 20 moves the magnetic head 10 in the radial direction DR2 of the magneto-optical recording medium 8, and a piezoelectric element 24 moves the magnetic head 10 in the tangential direction DR1 of the magneto-optical recording medium 8. When a prescribed voltage is applied to the piezoelectric element 20, the piezoelectric element 20 expands in the radial direction DR2 of the magneto-optical recording medium 8, to move the support plate 14 and the arm 13 in the radial direction DR2 of the magneto-optical recording medium 8. Therefore, the ratio of expansion of the piezoelectric element 20 can be varied by controlling the voltage applied to the piezoelectric element 20, for adjusting the position of the magnetic head 10 in the radial direction DR2 of the magneto-optical recording medium 8.

When a prescribed voltage is applied to the piezoelectric element 24, the piezoelectric element 24 expands in the tangential direction DR1 of the magneto-optical recording medium 8, to move the support plate 14 and the arm 13 in the tangential direction DR1 of the magneto-optical recording medium 8. Therefore, the ratio of expansion of the piezoelectric element 24 can be varied by controlling the voltage applied to the piezoelectric element 24, for adjusting the position of the magnetic head 10 in the tangential direction DR1 of the magneto-optical recording medium 8.

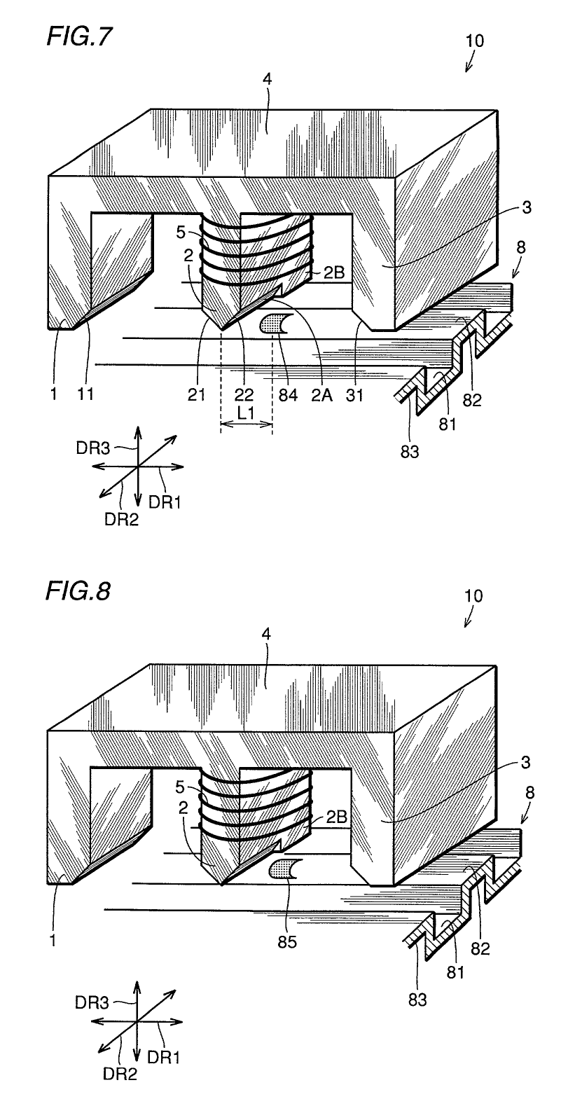

Referring to FIG. 7, a signal is reproduced from the magneto-optical recording medium 8 by domain expansion with the first portion 2A of the second leg 2 of the core 4 forming the magnetic head 10 according to the present invention. The magnetic head 10 is so arranged that the first leg 1, the second leg 2 and the third leg 3 of the core 4 are in the tangential direction DR1 of the magneto-optical recording medium 8. Thus, the first portion 2A and the second portion 2B of the second leg 2 are arranged in the radial direction DR2 of the magneto-optical recording medium 8. In the magneto-optical recording medium 8, grooves 81 and lands 82 are alternately arranged in the radial direction DR2. The magnetic film 83 is formed to cover the grooves 81 and the lands 82. This magnetic film 83 has a sectional structure formed with a recording layer, a nonmagnetic layer and a reproducing layer successively from the side closer to the magnetic head 10. The position of the magnetic head 10 is controlled with the piezoelectric elements 20 and 24 shown in FIG. 6 so that the first portion 2A of the second leg 2 formed by the inclined surfaces 21 and 22 is positioned on the land 82 of the magneto-optical recording medium 8 and displaced from a magnetic domain 84 formed on the magnetic film 83 located on the land 82 by a distance L1 in the tangential direction DR1 of the magneto-optical recording medium 8. The signal is reproduced by domain expansion with the magnetic field H21 outgoing from the inclined surface 22 and the magnetic field H11 outgoing from the inclined surface 21 by a method described later. The distance L1 is set to 100 μm.

In order to record a signal in the magneto-optical recording medium 8, the position of the magnetic head 10 in the radial direction DR2 is controlled with the piezoelectric elements 20 and 24 shown in FIG. 6 so that the second portion 2B of the second leg 2 of the core 4 is positioned on the land 82 of the magneto-optical recording medium 8, as shown in FIG. 8. A current is fed to the coil 5 for applying the magnetic field H3 modulated by the recorded signal from the second portion 2B to the magnetic film 83 of the magneto-optical recording medium 8, thereby forming a magnetic domain 85 on the land 82 and the signal is recorded.

As described with reference to FIGS. 7 and 8, the present invention is characterized in that the magnetic field H3, perpendicular to the magneto-optical recording medium 8, outgoing from the second portion 2B of the second leg 2 of the magnetic head 10 is employed for recording the signal in the magneto-optical recording medium 8 while the magnetic fields H11 and H21, including the field components in the in-plane direction of the magneto-optical recording medium 8, outgoing from the first portion 2A of the second leg 2 of the magnetic head 10 are employed for reproducing the signal from the magneto-optical recording medium 8 by domain expansion.

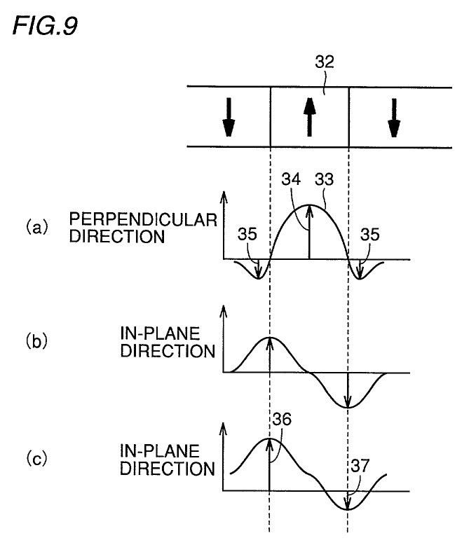

The principle of reproducing a signal from the magneto-optical recording medium 8 by domain expansion applying a magnetic field including a field component in the in-plane direction of the magneto-optical recording medium 8, is described with reference to FIGS. 9 to 12. When a magnetic domain 32 is formed on the recording layer as shown in FIG. 9, the intensity of a leakage field leaking from the magnetic domain 32, which is perpendicular to the magneto-optical recording medium 8, becomes larger as it goes from the both ends toward the center of the magnetic domain 32, and exhibit a distribution 33 having a magnetic field 34 at the center. Magnetic fields 35 opposite to the magnetic field 34 are present outside the both ends of the magnetic domain 32 ((a) in FIG. 9). On the other hand, the intensity of a leakage magnetic field leaking from the magnetic domain 32 in the in-plane direction of the magneto-optical recording medium 8 is maximized on both ends of the magnetic domain 32, to exhibit the opposite field distributions each other ((b) in FIG. 9). When the magnetic field including the field component in the in-plane direction of the magneto-optical recording medium 8 is applied, a leakage field in the in-plane direction leaking from the magnetic domain 32 is distributed to have a strong magnetic field 36 on a first end of the magnetic domain 32 while having a magnetic field 37 opposite to and weaker than the magnetic field 36 on a second end ((c) in FIG. 9). When the magnetic field including the field component in the in-plane direction of the magneto-optical recording medium 8 is applied, therefore, the leakage field in the in-plane direction would have a higher strength on the first end of the magnetic domain 32 so that the magnetic domain 32 is readily transferred to the reproducing layer through the nonmagnetic layer by magnetostatic coupling. In other words, the leakage fields in the in-plane direction leaking from both ends of the magnetic domain 32 are unbalanced and the magnetic domain 32 is preferentially transferred to the reproducing layer by the leakage field from the first end.

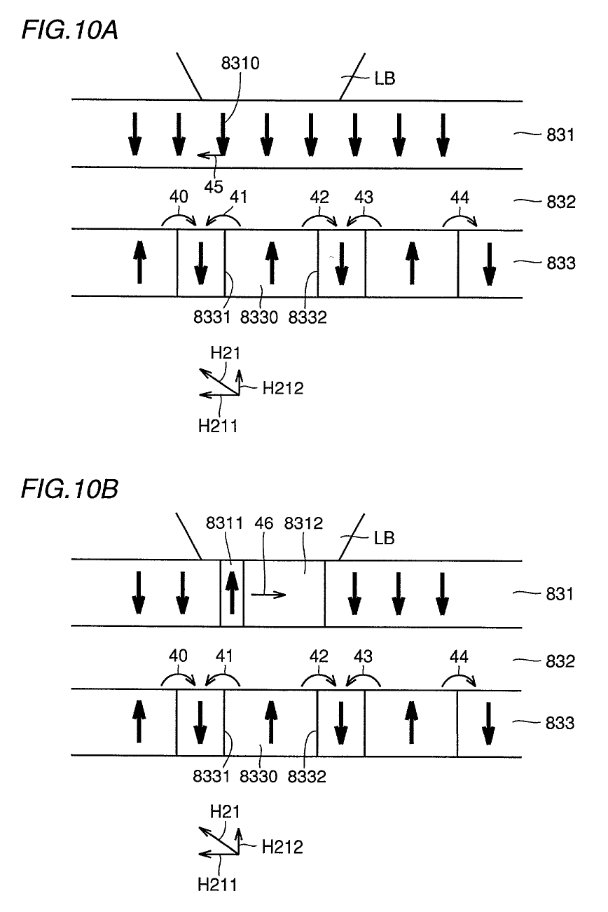

Referring to FIGS. 10A and 10B, the magnetic layers 83 of the magneto-optical recording medium 8 consists of a reproducing layer 831, a nonmagnetic layer 832 and a recording layer 833. The recording layer 833 is formed with magnetic domains magnetized in different directions based on the recorded signal. When the signal is reproduced by domain, the reproducing layer 831 is initialized to be magnetized in a uniform direction, and the laser beam LB is irradiated from the side of the reproducing layer 831. Leakage magnetic fields 40, 41, 42, 43 and 44 in the in-plane direction are present on the boundaries between the magnetic domains of the recording layer 833. When the laser beam LB was irradiated, the temperature at an area of a magnetic domain 8330 is increased to enlarge the intensity of the leakage magnetic fields 41 and 42. When a magnetic field H21, including the field component H211 in the same direction as the leakage field 41, is applied to the boundary 8331, the intensity of the leakage field 41 exceeds that of the leakage field 42, to exert a magnetic force 45 on magnetization 8310 of the reproducing layer 831 (FIG. 10A). Thus, the magnetization 8310 is readily rotated in the direction of the magnetic force 45, and a seed domain 8311 magnetized in the same direction as the magnetization 8330 appears on the reproducing layer 831. The applied magnetic field H21 also includes the field component H212 in the same direction as the magnetization of the seed domain 8311, which in turn is enlarged along arrow 46 so that an enlarged domain 8312 appears on the reproducing layer 831. This magnetic domain 8312 is detected with the laser beam LB, so that the magnetic domain 8330 of the recording layer 833 is reproduced by domain expansion (FIG. 10B). After the magnetic domain 8312 was detected, a magnetic field opposite to the magnetic field H21 is so applied that the magnetic domain 8312 is disappeared and the reproducing layer 831 returns to the initialized state. Thus, the magnetic domain is transferred to the reproducing layer 831 and enlarged therein, preferentially from one end of the magnetic domain, when the magnetic field H21 is applied to the boundary having the leakage field 43 which have the same polarity as the leakage field 41, and the magnetic domain transferred to the reproducing layer 831 and enlarged therein can be disappeared by applying a magnetic field opposite to the magnetic field H21.

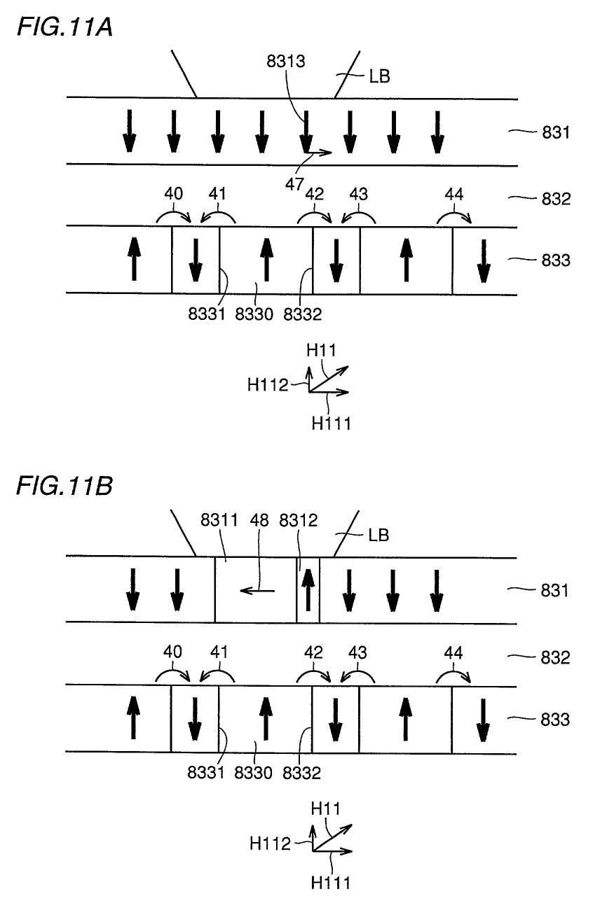

In order to reproduce the magnetic domain 8330 by domain expantion correctly inclusive of the domain length, an alternating field must be applied to a boundary 8332 on a second end for transferring and enlarging the magnetic domain 8330 to the reproducing layer 831, as shown in FIGS. 11A and 11B. After the magnetic field H21 was applied to the boundary 8331 on the first end of the magnetic domain 8330 for reproducing the same by domain expansion, therefore, the magnetic field H11 is applied to the boundary 8332 on the second end of the magnetic domain 8330. The laser beam LB is applied to increase the temperature of the area of the magnetic domain 8330 and increase the intensity of the leakage field 41 and the leakage field 42, while the intensity of the leakage field 42 exceeds that of the leakage field 41 due to the application of the magnetic field H11 including the field component H111 of the same direction as the leakage field 42. Thus, magnetic force 47 is exerted on magnetization 8313 of the reproducing layer 831 (FIG. 11A). The magnetization 8313 subjected to the magnetic force 47 is readily rotated in the direction of the magnetic force 47, and a seed domain 8313 magnetized in the same direction as the magnetic domain 8330 appears on the reproducing layer 831. The applied magnetic field H11 also includes the field component H112 which is the same direction as the magnetization of the seed domain 8314, so that the seed domain 8314 is enlarged along an arrow 48 and an enlarged domain 8315 appears on the reproducing layer 831. This magnetic domain 8315 is detected with the laser beam LB, so that the magnetic domain 8330 of the recording layer 833 is reproduced by the domain expansion (FIG. 11B). After the magnetic domain 8315 is detected, a magnetic field opposite to the magnetic field H11 is applied so that the magnetic domain 8315 is collapsed and the reproducing layer 831 returns to the initialized state. Thus, the magnetic domain is transferred and enlarged to the reproducing layer 831 preferentially from the second end of the magnetic domain when the field H11 is applied to the boundaries having the leakage fields 40 and 44 of the same polarity as the leakage field 42, and the magnetic domain transferred and enlarged to the reproducing layer 831 can be collapsed by applying a magnetic field opposite to the magnetic field H11.

As described with reference to FIGS. 10A and 10B and FIGS. 11A and 11B, when an alternating field, having a prescribed angle with respect to the in-plane direction of the magneto-optical recording medium 8, is applied for reproducing the signal by the domain expantion, each domain of the recording layer 833 is transferred and enlarged to the reproducing layer 831 preferentially from both ends thereof, the magnetic domain is detected with the laser beam LB, and the enlarged magnetic domain is thereafter collapsed. The magnetic fields H21 and H11 cannot be simultaneously applied to the boundaries 8331 and 8332 of the magnetic domain 8330 in the recording layer 833, and hence the magnetic field H21 is first applied to the boundary 8331 for detecting the magnetic domain 8330 by the domain expansion, and the magnetic field H11 is thereafter applied to the boundary 8332 for detecting the magnetic domain 8330 by the domain expansion. Because it is difficult to apply the magnetic fields H11 and H21 to both ends of each magnetic domain and to detect both ends of every domain by the domain expansion, a magnetic field is applied to the boundary on a first end having a leakage field of the same polarity every prescribed unit for reproducing the signal by the domain expansion from the first end of the magnetic domain and after a first magneto-optical signal was detected, an another magnetic field is applied to the boundary on a second end for reproducing the signal by the domain expansion from the second end of the magnetic domain and detecting a second magneto-optical signal. The detected first magneto-optical signal is composited with the second magneto-optical signal, to obtain a reproduced signal.

In other words, the magnetic field H21 is applied to the boundary having the leakage field with the same polarity as the leakage field 41 in the recording layer 833 for reproducing the signal by the domain expansion from the first end of the magnetic domain and after the first magneto-optical signal was detected, the magnetic field H11 is applied to the boundary having the leakage field with the same polarity as the leakage field 42 for reproducing the signal by the domain expansion from the second end of the magnetic domain to detect the second magneto-optical signal. The detected first magneto-optical signal is composited with the second magneto-optical signal. In order to detect the second magneto-optical signal after detecting the first magneto-optical signal, the magnetic head 10 is moved in the tangential direction DR1 of the magneto-optical recording medium 8 to a position where the magnetic field H11 outgoing from the second inclined surface 21 of the second leg 2 is applied to the second end of the magnetic domain 84 (see FIG. 7).

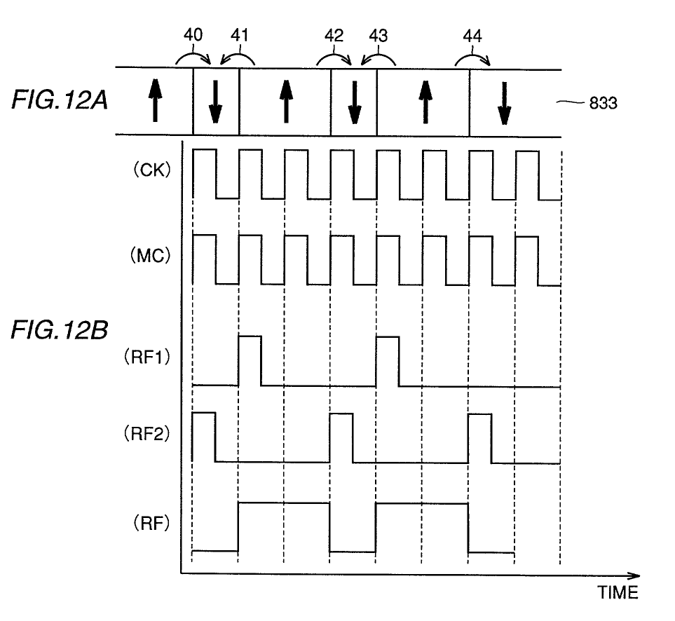

When the magnetic fields H11 and H21 are applied to the both ends of the each magnetic domain of the recording layer 833 for reproducing the signal by the domain expansion, the alternating field (MC) of the magnetic field H11 or H21 is applied in synchronization with a synchronous signal (CK) so that the first magneto-optical signal (RF1) is detected from the boundary having the leakage field with the same polarity as the leakage field 41 and the second magneto-optical signal (RF2) is detected from the boundary having the leakage field with the same polarity as the leakage field 42, as shown in FIGS. 12A and 12B. The signal processing is performed to be at a high logical level when the component of the first magneto-optical signal (RF1) is detected and to be at a low logical level when the second magneto-optical signal (RF2) is detected, thereby obtaining the reproduced signal (RF) by compositing the first magneto-optical signal (RF1) with the second magneto-optical signal (RF2).

Therefore, according to the present invention, a signal recorded in the magneto-optical recording medium 8 is divided into prescribed units, then the first magneto-optical signal (RF1) is detected from the first end of the each magnetic domain included in each prescribed unit and the second magneto-optical signal (RF2) is detected from the second end of the each magnetic domain, and the first magneto-optical signal (RF1) is composited with the second magneto-optical signal (RF2) for obtaining the reproduced signal (RF).

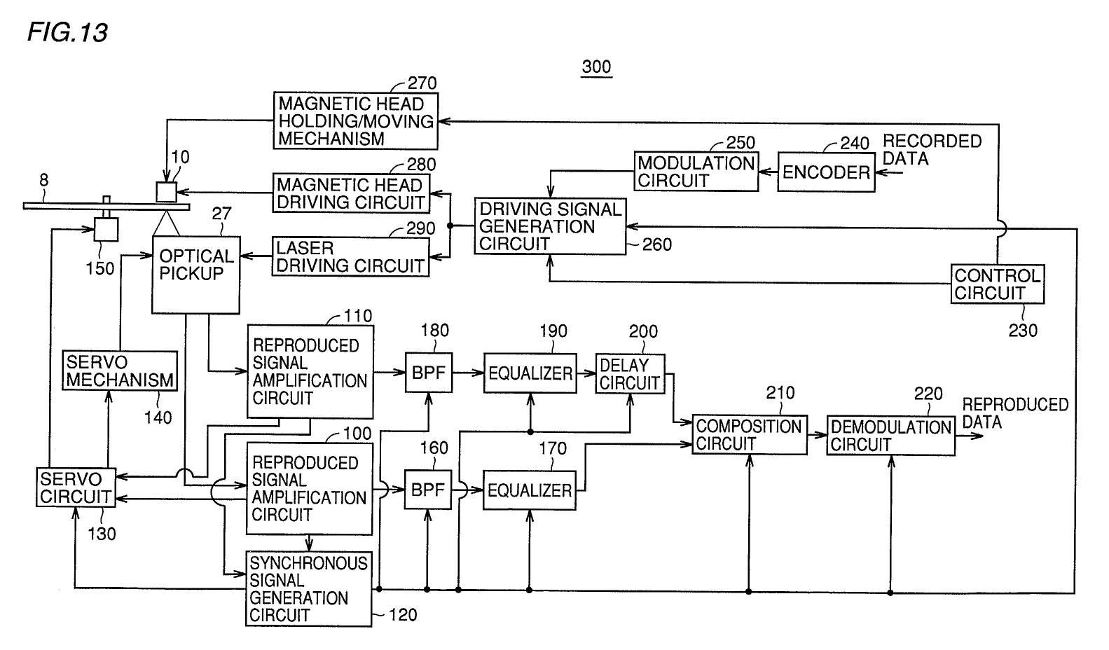

A recording/reproducing apparatus 300 according to the present invention is now described with reference to FIG. 13. The recording/reproducing apparatus 300 comprises the magnetic head 10, the optical pickup 27, the reproduced signal amplification circuits 100 and 110, a synchronous signal generation circuit 120, a servo circuit 130, a servo mechanism 140, a spindle motor 150, BPFs 160 and 180, equalizers 170 and 190, a delay circuit 200, a composition circuit 210, a demodulation circuit 220, a control circuit 230, an encoder 240, a modulation circuit 250, a driving signal generation circuit 260, a magnetic head holding/moving mechanism 270, a magnetic head driving circuit 280 and a laser driving circuit 290.

As described above, the magnetic head 10 applies an alternating field including a field component in the in-plane direction of the magneto-optical recording medium 8 or a magnetic field perpendicular to the magneto-optical recording medium 8 to the magneto-optical recording medium 8. The optical pickup 27 irradiates the magneto-optical recording medium 8 with a laser beam, and detects the reflected laser beam. The reproduced signal amplification circuit 100 amplifies a focus error signal, a tracking error signal, the first magneto-optical signal and a fine clock mark signal described later received from the optical pickup 27 to prescribed levels, and outputs the focus error signal and the tracking error signal to the servo circuit 130 while outputting the first magneto-optical signal (RF1) to the BPF 160 and outputting the fine clock mark signal to the synchronous signal generation circuit 120.

The reproduced signal amplification circuit 110 amplifies the focus error signal, the tracking error signal, the fine clock mark signal and the second magneto-optical signal (RF2) received from the optical pickup 27 to prescribed levels, and outputs the focus error signal and the tracking error signal to the servo circuit 130 while outputting the fine clock mark signal to the synchronous signal generation circuit 120 and outputting the second magneto-optical signal (RF2) to the BPF 180.

The synchronous signal generation circuit 120 generates a clock (CK) based on the fine clock mark signal by a method described later, and outputs the generated clock (CK) to the servo circuit 130, the BPFs 160 and 180, the equalizers 170 and 190, the delay circuit 200, the composition circuit 210, the demodulation circuit 220 and the driving signal generation circuit 260.

The servo circuit 130 controls the servo mechanism 140 to perform focus servo control and tracking servo control on the objective lens 28 provided in the optical pickup 27 for focusing and applying the laser beam to the magneto-optical recording medium 8 based on the focus error signal and the tracking error signal received from the reproduced signal amplification circuit 100 or 110. The servo circuit 130 rotates the spindle motor 10 at a prescribed rotational frequency based on the clock (CK) received from the synchronous signal generation circuit 120.

The servo mechanism 140 performs the focus servo control and the tracking servo control on the objective lens 28 focusing and applying the laser beam to the magneto-optical recording medium 8 under the control of the servo circuit 130. The spindle motor 150 rotates the magneto-optical recording medium 8 at a prescribed rotational frequency. The BPF 160 cuts some high-frequency components and some low-frequency component of the first magneto-optical signal (RF1) in synchronization with the clock (CK) received from the synchronous signal generation circuit 120. The equalizer 170 removes the waveform interference from the first magneto-optical signal (RF1) in synchronization with the clock (CK) received from the synchronous signal generation circuit 120. The BPF 180 cuts some high-frequency components and some low-frequency components of the second magneto-optical signal (RF2) in synchronization with the clock (CK) received from the synchronous signal generation circuit 120. The equalizer 190 removes the waveform interference from the second magneto-optical signal (RF2) in synchronization with the clock (CK) received from the synchronous signal generation circuit 120. The delay circuit 200 delays the phase of the second magneto-optical signal (RF2) by a prescribed amount in synchronization with the clock (CK) received from the synchronous signal generation circuit 120. The composition circuit 210 composites the first magneto-optical signal (RF1), received from the equalizer 170, with the second magneto-optical signal (RF2) received from the delay circuit 200, in synchronization with the clock (CK) received from the synchronous signal generation circuit 120.

The demodulation circuit 220 demodulates the composite magneto-optical signal received from the composition circuit 210 and outputs the demodulated signal as reproduced data in synchronization with the clock (CK) received from the synchronous signal generation circuit 120. The control circuit 230 controls the magnetic head holding/moving mechanism 270 to move the magnetic head 10 in the radial direction DR2 of the magneto-optical recording medium 8 so that the second portion 2B of the second leg 2 of the magnetic head 10 is located on the land 82 or the groove 81 of the magneto-optical recording medium 8 in order to record the signal in the magneto-optical recording medium 8. In order to reproduce the signal from the magneto-optical recording medium 8 by the domain expansion, the control circuit 230 controls the magnetic head holding/moving mechanism 270 to move the magnetic head 10 in the tangential direction DR1 of the magneto-optical recording medium 8 so that the first portion 2A of the second leg 2 of the magnetic head 10 is located on the land 82 or the groove 81 of the magneto-optical recording medium 8 and so that the magnetic field H11 or H21 can be applied to the end of the magnetic domain to be reproduced. Further, the control circuit 230 controls the driving signal generation circuit 260.

The encoder 240 encodes recorded data. The modulation circuit 250 modulates the recorded signal to a prescribed system. In order to record the signal in the magneto-optical recording medium 8, the driving signal generation circuit 260 generates a driving signal for generating a magnetic field modulated by the recorded signal received from the modulation circuit 250 based on the clock (CK) received from the synchronous signal generation circuit 120, and outputs the generated driving signal to the magnetic head driving circuit 280. The driving signal generation circuit 260 further generates a driving signal for forming a laser beam having constant intensity, and outputs the generated driving signal to the laser driving circuit 290.

In order to reproduce the signal from the magneto-optical recording medium 8, the driving signal generation circuit 260 generates a driving signal for generating an alternating field consisting of the magnetic field H11 and a magnetic field opposite to the magnetic field H11 or an alternating field consisting of the magnetic field H21 and a magnetic field opposite to the magnetic field H21 and outputs the generated driving signal to the magnetic head driving circuit 280, while generating a driving signal for forming a laser beam having a constant intensity and outputting the generated driving signal to the laser driving circuit 290.

The magnetic head holding/moving mechanism 270, consisting of the arm 13, the support plate 14, the top plate 15, the springs 16A and 16B, the magnets 17A and 17B, the core 18, the coil 19 and the piezoelectric elements 20 and 24 shown in FIGS. 4 and 6, moves and holds the magnetic head 10 in the tangential direction DR1 or the radial direction DR2 of the magneto-optical recording medium 8. The magnetic driving circuit 280 drives the magnetic head 10 based on the driving signal from the driving signal generation circuit 260. The laser driving circuit 290 drives a semiconductor laser (not shown) provided in the optical pickup 27 based on the driving signal received from the driving signal generation circuit 260.

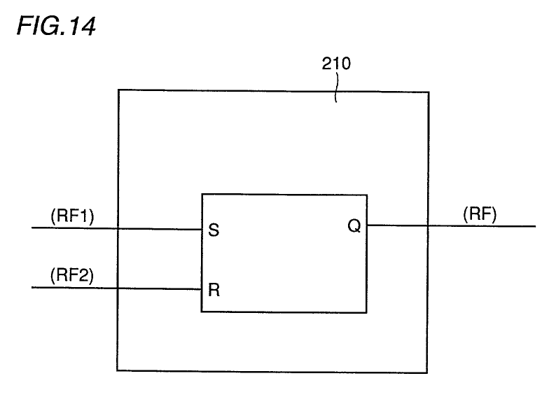

Referring to FIG. 14, the composition circuit 210 is formed by an S-R flip-flop. When the first magneto-optical signal (RF1) is input in an S terminal and the second magneto-optical signal (RF2) is input in an R terminal, the reproduced signal (RF) is output from a Q terminal.

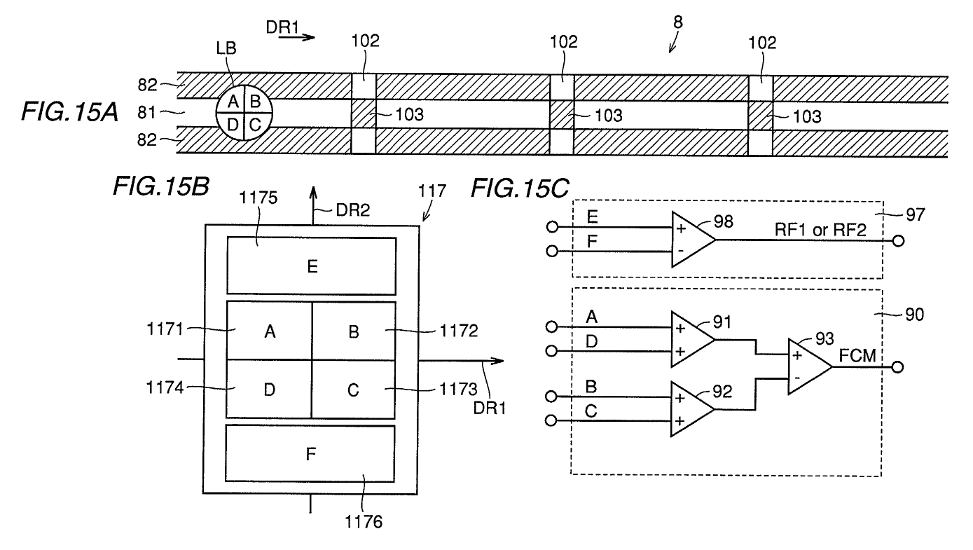

Detection of the first magneto-optical signal (RF1), the second magneto-optical signal (RF2) and the fine clock mark signal (FCM) in a photodetector 117, which is included in the optical pickup 27, is described with reference to FIGS. 15A to 15C. The photodetector 117 has six areas 1171 to 1176. The area A 1171 and the area B 1172 as well as the area C 1173 and the area D 1174 are arranged in the tangential direction DR1 of the magneto-optical recording medium 8, while the area A 1171 and the area D1174, the area B 1172 and the area C 1173, and the area E 1175 and the area F 1176 are arranged in the radial direction DR2 of the magneto-optical recording medium 8 (see FIG. 15B).

The area A 1171, the area B 1172, the area C 1173 and the area D 1174 detect the laser beam LB, applied to the magneto-optical recording medium 8, reflected by areas A, B, C and D respectively. The area E 1175 and the area F 1176 detect the first magneto-optical signal (RF1) or the second magneto-optical signal (RF2) from the magneto-optical recording medium 8, as described later.

The lands 82 and the grooves 81 are alternately arranged on the magneto-optical recording medium 8 in the radial direction DR2, and short grooves 102 are formed on each of the lands 82 at a constant interval in the tangential direction DR1 while the short lands 103 are formed on the each of the groove 81 at a constant interval in the tangential direction DR1 (see FIG. 15A). In the present invention, the grooves 102 and the lands 103 are referred to as fine clock marks.

The fine clock marks 102 and 103 are detected by a tangential push-pull method as a value obtained by subtracting the sum of intensity [B] of the laser beam detected in the area B1172 and intensity [C] of the laser beam detected in the area C 1173 from the sum of intensity [A] of the laser beam detected in the area A 1171 and intensity [D] of the laser beam detected in the area D 1174. In other words, the fine clock marks 102 and 103 are detected by adders 91 and 92 and a subtracter 93 forming a circuit 90. The adder 91 outputs a value [A+D] obtained by adding the intensity [A] of the laser beam detected in the area A 1171 and the intensity [D] of the laser beam detected in the area D 1174, and the adder 92 outputs a value [B+C] obtained by adding the intensity [B] of the laser beam detected in the area B 1172 and the intensity [C] of the laser beam detected in the area C 1173. The subtracter 93 subtracts the output [B+C] of the adder 92 from the output [A+D] of the adder 91, and outputs a detection signal FCM=[A+D]−[B+C] from the fine clock marks 102 and 103.

The area E 1175 detects the S polarized component of the laser beam generated by a Wollaston polarizing prism (not shown) from the laser beam reflected by the magneto-optical recording medium 8 only, while the area F 1176 detects the P polarized component of the laser beam generated by the Wollaston polarizing prism only. The intensity [E] of the laser beam detected in the area E 1175 and the intensity [F] of the laser beam detected in the area F 1176 are input in a subtracter 98 of a circuit 97, so that the subtracter 97 operates the difference therebetween and outputs this difference as the first magneto-optical signal (RF1) or the second magneto-optical signal (RF2)=[E]−[F] (see FIG. 15C).

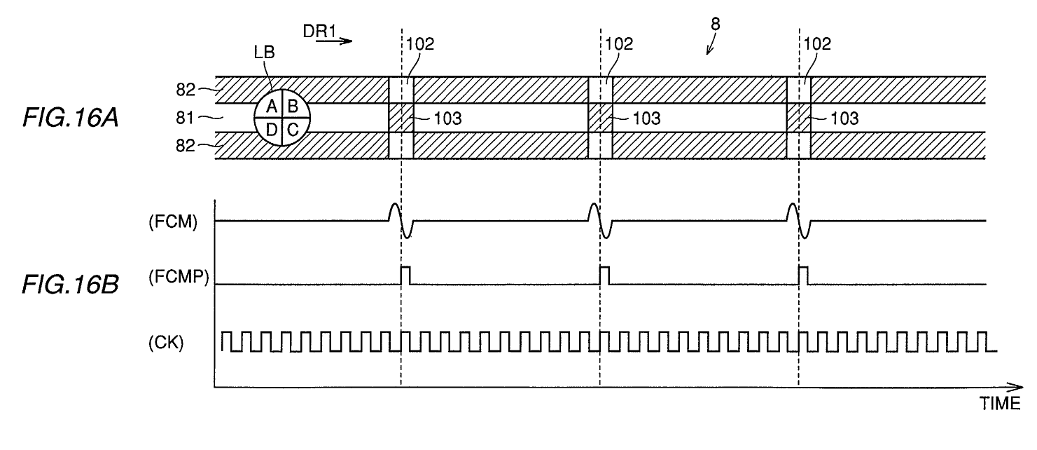

Generation of the clock (CK) in the synchronous signal generation circuit 120 of the recording/reproducing apparatus 300 shown in FIG. 13 is described with reference to FIGS. 16A an 16B. The laser beam LB scans the magneto-optical recording medium 8 in the tangential direction DR1, so that the photodetector 117 detects the fine clock mark signal (FCM) by the method described with reference to FIGS. 15A to 15C. The detected fine clock mark signal (FCM) is input in the synchronous signal generation circuit 120 through the reproduced signal amplification circuit 100 or 110. The synchronous signal generation circuit 120 generates a signal (FCMP) based on the fine clock mark signal (FCM), and generates the clock (CK) so that a constant number of periodic signals are present between the components of the signal (FCMP). In this case, the number of the periodic signals present between the components of the signal (FCMP) is 532, for example (see FIG. 16B).

As described above, the recording/reproducing apparatus 300 generates the clock (CK) on the basis of the fine clock marks 102 and 103 formed on the magneto-optical recording medium 8 for recording and/or reproducing the signal.

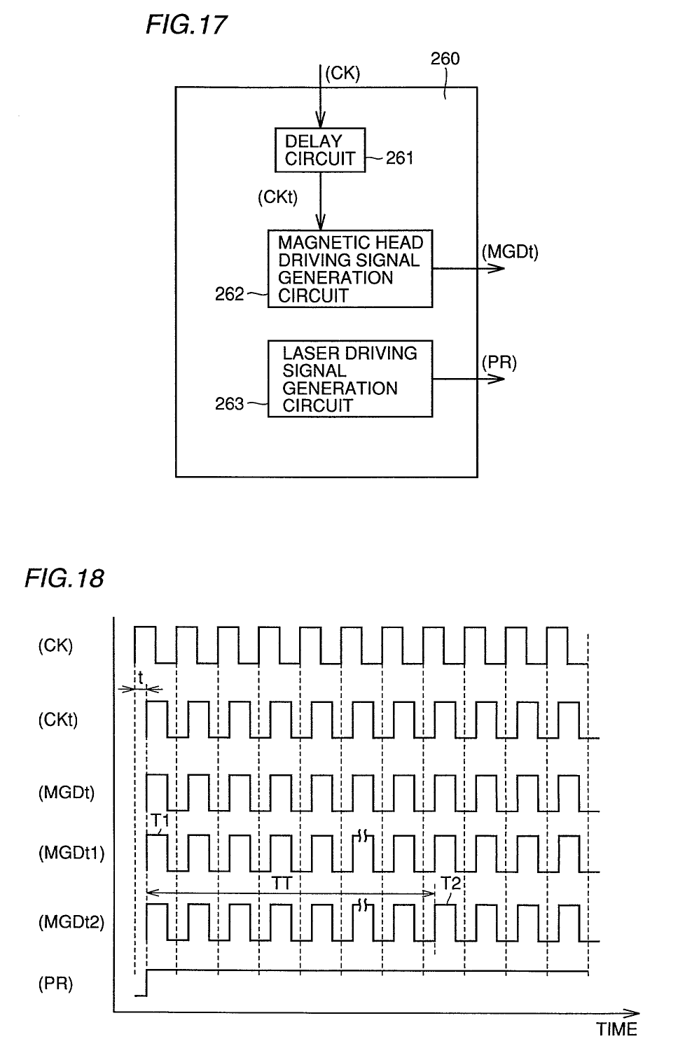

Referring to FIG. 17, the driving signal generation circuit 260 includes a delay circuit 261, a magnetic head driving signal generation circuit 262 and a laser driving signal generation circuit 263. The delay circuit 261 delays the phase of the clock (CK) by a constant amount. The magnetic head driving signal generation circuit 262 generates a driving signal for generating a magnetic field based on the clock received from the delay circuit 261, and outputs the driving signal to the magnetic head driving circuit 280. The laser driving signal generation circuit 263 generates a driving signal for forming a laser beam having constant intensity, and outputs the driving signal to the laser driving circuit 290.

Referring to FIG. 18, the delay circuit 261 receives the clock (CK) from the synchronous signal generation circuit 120, delays the phase of the clock (CK) by a constant amount t, and outputs a delayed clock (CKt) to the magnetic head driving signal generation circuit 262. The magnetic head driving signal generation circuit 262 generates a driving signal (MGDt) for generating an alternating field including the magnetic field H11 and an alternating field including the magnetic field H21 in synchronization with the delayed clock (CKt), and outputs the driving signal (MGDt) to the magnetic head driving circuit 280. The laser driving signal generation circuit 263 generates a driving signal (PR) for forming a laser beam having a constant intensity, and outputs the driving signal (PR) to the laser driving circuit 290.

The magnetic head driving circuit 280 drives the magnetic head 10 based on the driving signal (MGDt), so that the magnetic head 10 applies an alternating field Hex1 including the magnetic field H11 and an alternating field Hex2 including the magnetic field H21 to the magneto-optical recording medium 8 based on the driving signal (MGDt). The magnetic head 10 simultaneously generates the alternating field Hex1 including the magnetic field H11 and the alternating field Hex2 including the magnetic field H21 from the inclined surfaces 21 and 22 of the second leg 2 of the core 4 respectively, and hence the alternating fields Hex1 and Hex2 are simultaneously applied to the magneto-optical recording medium 8 by the driving signal (MGDt). As described above, however, the alternating fields Hex1 and Hex2 are applied to different positions. Therefore, considering a magnetic domain formed on the recording layer 833 of the magneto-optical recording medium 8 such as the magnetic domain 8330 (see FIGS. 10A and 10B), for example, the alternating field Hex2 is applied to the edge 8331 of the magnetic domain 8330 based on a driving signal (MGDt1) and the alternating field Hex1 is applied to the edge 8332 of the magnetic domain 8330 which is opposite to the edge 8331 based on a driving signal (MGDt2). In other words, the alternating field Hex2 is applied to the edge 8331 of the magnetic domain 8330 at the timing T1 of the driving signal (MGDt1), and the alternating field Hex1 is applied to the edge 8332 of the magnetic domain 8330 at the timing T2 of the driving signal (MGDt2) after a lapse of a time TT. Here, the TT stands for the time between the detection of the first magneto-optical signal (RF1), by means of applying an alternating magnetic field Hex2 to the first end of the each domains, to the beginning of the detection of the second magneto-optical signal (RF2), by means of applying an alternating magnetic field Hex1 to the second end of the each domains, when the signal recorded on the magneto-optical medium 8 was divided into a prescribed amount.

Referring again to FIG. 13, the magneto-optical recording medium 8 is mounted on the recording/reproducing apparatus 300 and rotated by the spindle motor 150 at the prescribed rotational frequency so that focus servo control and tracking servo control are turned on by the aforementioned operations, the synchronous signal generation circuit 120 generates the clock (CK), and the driving signal generation circuit 260 thereafter generates the driving signal (MGDt) for generating the alternating field Hex1 including the magnetic field H11 and the alternating field Hex2 including the magnetic field H21 and the driving signal (PR) for forming the laser beam under a control of the control circuit 230 for outputting the driving signal (MGDt) to the magnetic head driving circuit 280 while outputting the driving signal (PR) to the laser driving circuit 290. The magnetic head driving circuit 280 drives the magnetic head 10 based on the driving signal (MGDt), so that the magnetic head 10 applies the alternating field Hex1 to the first ends of the each magnetic domains formed on the magneto-optical recording medium 8 based on the driving signal (MGDt). The laser driving circuit 290 drives the semiconductor laser (not shown) provided in the optical pickup 27 based on the driving signal (PR), so that the optical pickup 27 irradiates the magneto-optical recording medium 8 with the laser beam. The photodetector 117 included in the optical pickup 27 detects the first magneto-optical signal (RF1) for the prescribed amount of signal. Thereafter the control circuit 230 controls the magnetic head holding/moving mechanism 270 to move the magnetic head 10 in the tangential direction DR1 of the magneto-optical recording medium 8 for applying the alternating field Hex2 to the second ends of the each magnetic domains. After the magnetic head holding/moving mechanism 270 moves the magnetic head 10 in the tangential direction DR1 of the magneto-optical recording medium 8 under a control of the control circuit 230, the magnetic head 10 applies the alternating field Hex2 to the second ends of the each magnetic domains formed on the magneto-optical recording medium 8 based on the driving signal (MGDt). The photodetector 117 included in the optical pickup 27 detects the second magneto-optical signal (RF2) for the prescribed amount of signal. The detected first magneto-optical signal (RF1) is input in the composition circuit 210 through the reproduced signal amplification circuit 110, the BPF 160 and the equalizer 170. The detected second magneto-optical signal (RF2) is input in the delay circuit 200 through the reproduced signal amplification circuit 110, the BPF 180 and the equalizer 190, and the phase thereof is delayed by the delay circuit 200 by a constant amount TT. The second magneto-optical signal (RF2), having delayed in phase, is input in the composition circuit 210, which in turn composites the first magneto-optical signal (RF1) with the second magneto-optical signal (RF2), having delayed in phase, and outputs the composited magneto-optical signal to the demodulation circuit 220. The demodulation circuit 220 demodulates the composite magneto-optical signal and outputs the demodulated signal as the reproduced data.

In order to record a signal by the recording/reproducing apparatus 300, the magnetic head holding/moving mechanism 270 moves the magnetic head 10 so that the second portion 2B of the second leg 2 of the magnetic head 10 is positioned on the groove 81 or the land 82 of the magneto-optical recording medium 8. The recorded data is encoded by the encoder 240, then is modulated by the modulation circuit 250 to a prescribed system, and is thereafter input in the driving signal generation circuit 260. The driving signal generation circuit 260 generates a driving signal for generating a magnetic field modulated by the recorded signal in synchronization with the delayed clock (CKt) obtained by delaying the phase of the clock (CK) by a constant amount, and outputs the driving signal to the magnetic head driving circuit 280. The magnetic head driving circuit 280 drives the magnetic head 10 based on the received driving signal, so that the magnetic head 10 applies the magnetic field modulated by the recorded signal to the magneto-optical recording medium 8. The driving signal generation circuit 260 also generates a driving signal for forming a laser beam having an intensity sufficient for recording the signal, and outputs the driving signal to the laser driving circuit 290. The laser driving circuit 290 drives the semiconductor laser provided in the optical pickup 27 based on the received driving signal, so that the optical pickup 27 irradiates the magneto-optical recording medium 8 with the laser beam. Thus, the signal can be recorded in the magneto-optical recording medium 8.

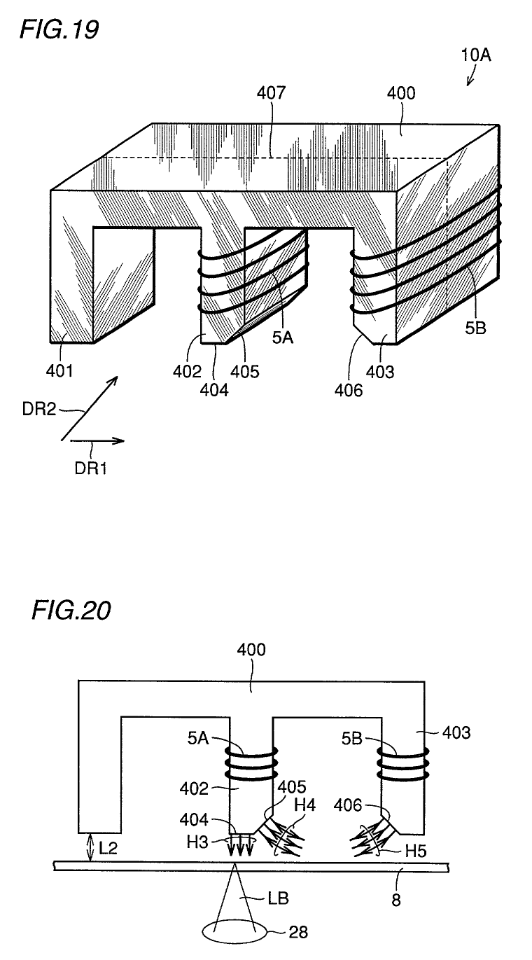

The magnetic head according to the present invention may be a magnetic head 10A shown in FIG. 19. The magnetic head 10A consists of a core 400 and coils 5A and 5B. The core 400 includes a first leg 401, a second leg 402 and a third leg 403. The coil 5A is wound on the second leg 402 of the core 400. The coil 5B is wound on the third leg 403 of the core 400. The second leg 402 includes a flat surface 404 and an inclined surface 405. The third leg 403 includes an inclined surface 406. The inclined surfaces 405 and 406 are opposed to each other, so that a magnetic field outgoing from the inclined surface 405 is incident on the inclined surface 406. The first leg 401, the second leg 402 and the third leg 403 are arranged in the tangential direction DR1 of the magneto-optical recording medium 8. In the tangential direction DR1 and the radial direction DR2 of the magneto-optical recording medium 8, the first leg 401, the second leg 402 and the third leg 403 are identical in width to those of the aforementioned core 4.

When a current is fed to the coil 5A, a magnetic field H3 outgoes from the flat surface 404, and a magnetic field H4 outgoes from the inclined surface 405, as shown in FIG. 20. When a current is fed to the coil 5B, a magnetic field H5 outgoes from the inclined surface 406. The distance L2 between the core 400 and the magneto-optical recording medium 8 is about 20 μm.

In order to reproduce a signal from the magneto-optical recording medium 8, therefore, a current is fed to the coil 5A for applying the magnetic field H4 to the magneto-optical recording medium 8 and reproducing a magnetic domain from a first end of the magnetic domain having a leakage field with the same polarity, by the domain expansion, and thereafter a current is fed to the coil 5B for applying the magnetic field H5 to the magneto-optical recording medium 8 and reproducing a magnetic domain from a second end of the magnetic domain, having a leakage field with the same polarity, by domain expansion. Two magneto-optical signals are composited with each other by the aforementioned method, for obtaining a reproduced signal. When the magnetic domain is reproduced from the first end by the domain expansion with the magnetic field H4, and thereafter the magnetic field is reproduced from the second end by the domain expansion with the magnetic field H5, the magnetic head 10A must be moved in the tangential direction DR1 of the magneto-optical recording medium 8 so that the optical axis of a laser beam LB moves from the second leg 402 to the third leg 403. The distance of this movement is about 500 μm, and hence the piezoelectric element 24 shown in FIG. 6 is employed for moving the magnetic head 10A in the tangential direction DR1 of the magneto-optical recording medium 8.

In order to record a signal in the magneto-optical recording medium 8, a current is fed to the coil 5A for applying the magnetic field H3 to the magneto-optical recording medium 8. The magnetic field H4 is also simultaneously applied to the magneto-optical recording medium 8 in this case, and hence the current fed to the coil 5A is so controlled that a magnetic domain is formed not at the intensity of the magnetic field H4 but at the intensity of the magnetic field H3. Further, the magnetic head 10A is moved in the tangential direction DR1 of the magneto-optical recording medium 8 so that the optical axis of the laser beam LB moves from the inclined surface 405 to the flat surface 404 of the second leg 402. The distance of this movement is about several 10 μm, and hence the piezoelectric element 24 shown in FIG. 6 is employed also in this case for moving the magnetic head 10A in the tangential direction DR1 of the magneto-optical recording medium 8.

Therefore, the signal can be recorded in the magneto-optical recording medium 8 with the magnetic head 10A, and can be reproduced by the domain expansion by applying an oblique magnetic field to the magneto-optical recording medium 8.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A magnetic head applying magnetic fields to a magneto-optical recording medium, comprising:
a first field generation part generating a first magnetic field substantially perpendicular to said magneto-optical recording medium; and
a second field generation part generating a second magnetic field having a prescribed angle with respect to the in-plane direction of said magneto-optical recording medium.

2. The magnetic head according to claim 1, wherein said second field generation part generates two said second magnetic fields symmetrical with respect to the normal direction of said magneto-optical recording medium.

3. The magnetic head according to claim 1, wherein a component of said second magnetic field in the in-plane direction of said magneto-optical recording medium has higher field strength than a component of said second magnetic field perpendicular to said magneto-optical recording medium.

4. A magnetic head applying magnetic fields to a magneto-optical recording medium, comprising:
a core including a first leg, a second leg and a third leg, substantially in the form of square poles, extending toward said magneto-optical recording medium; and
a coil wound on said second leg of said core, wherein
said second leg is arranged between said first leg and said third leg and includes a first portion and a second portion,
said first portion has first and second inclined surfaces so that the center of a sectional structure in the tangential direction of said magneto-optical recording medium is pointed toward said magneto-optical recording medium,
said second portion has a flat surface opposed to said magneto-optical recording medium,
said first leg has a third inclined surface receiving a magnetic line outgoing from said first inclined surface, and
said third leg has a fourth inclined surface receiving a magnetic line outgoing from said second inclined surface.

5. A magnetic head applying magnetic fields to a magneto-optical recording medium, comprising:
a core including a first leg, a second leg and a third leg, substantially in the form of square poles, extending toward said magneto-optical recording medium;
a first coil wound on said second leg of said core; and
a second coil wound on said third leg of said core, wherein
said second leg is arranged between said first leg and said third leg and has a flat surface opposed to said magneto-optical recording medium and a first inclined surface inclined to be separated from said magneto-optical recording medium in the tangential direction of said magneto-optical recording medium, and
said third leg has a second inclined surface receiving a magnetic line outgoing from said first inclined surface.

6. A recording/reproducing apparatus recording and reproducing a signal in and from a magneto-optical recording medium, comprising:
a magnetic head including a first field generation part generating a first magnetic field substantially perpendicular to said magneto-optical recording medium and a second field generation part generating a second magnetic field having a prescribed angle with respect to the in-plane direction of said magneto-optical recording medium;
an optical pickup irradiating said magneto-optical recording medium with a laser beam and detecting reflected said laser beam; and
a magnetic head moving mechanism moving said magnetic head for applying a magnetic field generated from said first field generation part of said magnetic head to an area of said magneto-optical recording medium irradiated with said laser beam for recording a signal in said magneto-optical recording medium, and
applying a magnetic field generated from said second field generation part of said magnetic head to an area of said magneto-optical recording medium irradiated with said laser beam for reproducing a signal from said magneto-optical recording medium.

7. A recording/reproducing apparatus recording and reproducing a signal in and from a magneto-optical recording medium, comprising:
a magnetic head applying magnetic fields to said magneto-optical recording medium;
a magnetic head driving circuit driving said magnetic head;
an optical pickup irradiating said magneto-optical recording medium with a laser beam and detecting reflected said laser beam; and
a magnetic head holding/moving mechanism holding or moving said magnetic head, wherein
said magnetic head includes:
a core including a first leg, a second leg and a third leg, substantially in the form of square poles, extending toward said magneto-optical recoding medium, and
a coil wound on said second leg of said core,
said second leg is arranged between said first leg and said third leg and has a first portion and a second portion,
said first portion has first and second inclined surfaces so that the center of a sectional structure in the tangential direction of said magneto-optical recording medium is pointed toward said magneto-optical recording medium,
said second portion has a flat surface opposed to said magneto-optical recording medium,
said first leg has a third inclined surface receiving a magnetic line outgoing from said first inclined surface,
said third leg has a fourth inclined surface receiving a magnetic line outgoing from said second inclined surface, and
said magnetic head holding/moving mechanism holds said magnetic head so that said first, second and third legs of said magnetic head are arranged in the tangential direction of said magneto-optical recording medium,
moves and holds said magnetic head so that a magnetic field generated from said second portion of said second leg of said magnetic head is applied to an area of said magneto-optical recording medium irradiated with said laser beam for recording a signal in said magneto-optical recording medium, and
moves and holds said magnetic head so that a magnetic field generated from said first portion of said second leg of said magnetic head is applied to an area of said magneto-optical recording medium irradiated with said laser beam at a prescribed angle with respect to the in-plane direction of said magneto-optical recoding medium for reproducing a signal from said magneto-optical recording medium.

8. A recording/reproducing apparatus recording and reproducing a signal in and from a magneto-optical recording medium, comprising:
a magnetic head applying magnetic fields to said magneto-optical recording medium;
a magnetic head driving circuit driving said magnetic head;
an optical pickup irradiating said magneto-optical recording medium with a laser beam and detecting reflected said laser beam; and
a magnetic head holding/moving mechanism holding or moving said magnetic head, wherein
said magnetic head includes:
a core including a first leg, a second leg and a third leg, substantially in the form of square poles, extending toward said magneto-optical recording medium,
a first coil wound on said second leg of said core, and
a second coil wound on said third leg of said core,
said second leg is arranged between said first leg and said third leg and has a flat surface opposed to said magneto-optical recording medium and a first inclined surface inclined to be separated from said magneto-optical recording medium in the tangential direction of said magneto-optical recording medium,
said third leg has a second inclined surface receiving a magnetic line outgoing from said first inclined surface, and
said magnetic head holding/moving mechanism holds said magnetic head so that said first, second and third legs of said magnetic head are arranged in the tangential direction of said magneto-optical recording medium,
moves and holds said magnetic head so that a magnetic field generated from said flat surface of said second leg is applied to an area of said magneto-optical recording medium irradiated with said laser beam for recording a signal in said magneto-optical recording medium, and
moves and holds said magnetic head so that a magnetic field generated from said first inclined surface of said second leg or said second inclined surface of said third leg is applied to an area of said magneto-optical recording medium irradiated with said laser beam at a prescribed angle with respect to the in-plane direction of said magneto-optical recording medium for reproducing a signal from said magneto-optical recording medium.
